(19) United States
(12) Patent Application Publication
(10) Pub. No.: US 2015/0250091 A1
(43) Pub. Date: Sep. 10, 2015

(54) SEED TREATMENT DEVICE

(71) Applicant: ROBERT D. AANESTAD, Isle, MN (US)

(72) Inventor: ROBERT D. AANESTAD, Isle, MN (US)

(73) Assignee: Robert Donovan Aanestad, Isle, MN (US)

(21) Appl. No.: 14/200,479

(22) Filed: Mar. 7, 2014

(51) Int. Cl. A01C 1/06; A01C 7/20

(52) U.S. Cl. CPC A01C 1/06; A01C 7/20

(57) ABSTRACT

A seed treater having liquid conveyed under pressure to a plurality of nozzle shields in a fixed relationship to corresponding seed receivers in a seed box. When used with a grain box or a grain drill, the inventive device conveys material such as seed treatment under pressure to the nozzle shields with each of said nozzle shields having an orifice therein whereby a predetermined quantity of said material is ejected via each of said nozzle shields onto the seed. Where row crop planters are used, the material is conveyed under pressure to the individual seed boxes.

### BACKGROUND OF THE INVENTION

This invention relates to a seed treater and, more particularly, a seed treater of the type wherein the treatment of the seed takes place within the seed box itself under pressure thereby enabling uniform treatment of the seed. The apparatus is so designed that it can be easily attached to all seed assemblies having either a grain box or a grain drill or with slight modification can be attached to seeders having a plurality of individual boxes.

Present state of the art seed treaters all attempt to convey the treatment material directly to the ground and upon or close to the seeds dispersed therein. In such cases it is difficult to obtain uniform treating of the seeds because of the distance the treatment material is required to travel and because of the means used to convey the material.

The treatment material is conveyed to the seed by prior art apparatus either by gravity feed as shown in U.S. Pat. Nos. 3,554,145, 3,512,489, 3,453,977, 3,122,111 and 2,874,8878 or pneumatically as shown in U.S. Pat. Nos. 3,548,765 and 3,161,985. In all of these patents, the treatment material is disbursed directly in the ground and a perusal of the patents will quickly reveal that treatment cannot be uniform in relation to each seed placed in the ground.

### SUMMARY OF THE INVENTION

The present invention provides a solution to the aforementioned problems by presenting apparatus which not only applies seed treatment material to the seed being planted while the seed is in the seed box or the seeder just prior to the seed being fed out to conduits that deposit it into furrows in the ground; but, also allows the amount of treatment to be easily and quickly regulated by the operator. Material treatment nozzle shields are placed immediately above seed receiving cups on the bottom of the seed box to apply the treatment material directly to the seed just prior to its being transported to the ground via the conduits. A pressurized conveying system transports the liquified treatment material to the nozzle shields via tubing to the grain box or to row crop planters.

Thus, it is an object of the present invention to provide a seed treatment apparatus which can be easily attached to any existing grain drill or row crop planter.

It is also an object of the present invention to provide a seed treating apparatus wherein the seed is treated in the seed box just prior to its conveyance from the seed to the ground.

It is another important object of the present invention to provide a seed treater wherein the treatment material is applied to the seed in a wide dispersion of the material over the seed directly under the nozzle shield.

### BRIEF DESCRIPTION OF THE DRAWINGS

These and other more detailed and specific objects will be disclosed in the course of the following specification, reference being had to the accompanying drawings in which like numbers represent like objects in the various Figures and in which:

FIG. 1 is a schematic representation of the novel seed treater mounted on a typical seed drill frame;

FIG. 2 is a cross-section view of the nozzle shield, grain box, seed receiving cup and flexible conduit taken along section 2-2 of FIG. 1.

FIG. 3 is a schematic representation of the manifold which allows seed treatment material to be transmitted to individual nozzle shields in the individual seed boxes in a row crop planter

### DESCRIPTION OF THE PREFERRED EMBODIMENT

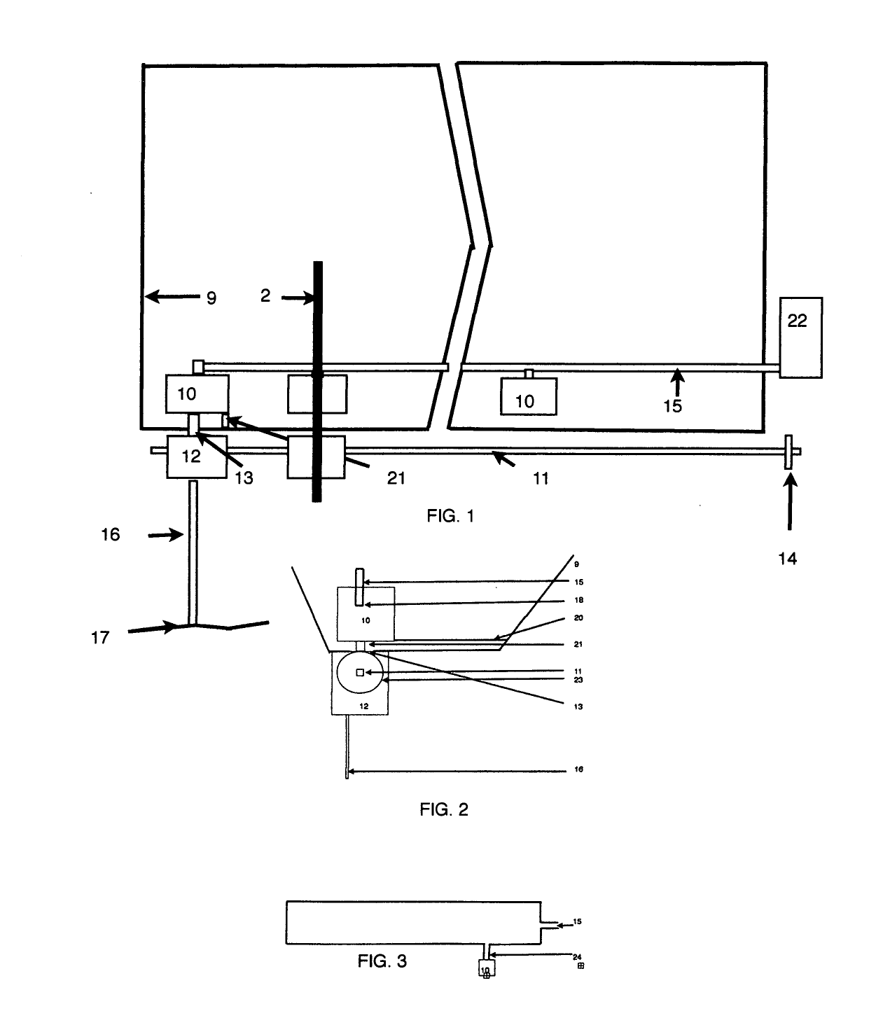

FIG. 1, grain box 9 is a typical grain box supported by a frame (not shown) and wheels (not shown) to carry the frame. A tube 15 passes through a plurality of nozzle shields 10. Each of said nozzle shields 10 has arms 21 extending vertically from said nozzle shield 10 and contacting the bottom of said box 9 to support said nozzle shield 10 above the bottom of said box 9. Located immediately under each of the nozzle shields 10 is an opening 13 in the bottom of the grain box through which grain may pass to seed receiving cups 12. The seed receiving cups 12 are well known in the art and may be attached to grain box 9 in any desired fashion such as by bolts (not shown). The seeds then pass from cups 12 through flexible conduit 16 to the ground 17.

The material handling system 22 is mounted in any suitable location on the drill frame and is powered by an electrical d.c. motor. Square shaft 11 is rotated in a well-known manner by the turning wheels of the grain drill. Square shaft 11 also passes through each of the seed receiving cups 12 to turn a notched wheel 23 (shown in FIG. 2) for carrying the received seed to flexible conduit 16 which deposits them in ground 17.

Six variables govern the rate, in ounces, of treatment per acre. A formula including these variables is provided the grain drill operator for his particular configuration. These variables include (1) drill width, (2) number of openings in drill box, (3) pounds of seed planted per acre, (4) ounces of treatment material per 100 pounds of seed, (5) travel speed, and (6) grain box capacity in pounds.

FIG. 2 is a cross-sectional view of the device shown in FIG. 1 along lines 2-2. Seed box 9 is filled with seed which surround nozzle shield 10. The nozzle shield is supported by arms 21. The nozzle shield is fastened to the grain box 9 by an arm 20 to the inside surface of grain box 9. Seed treatment is conveyed to seed through nozzle 18 located within nozzle shield 10. Nozzle shield 10 provides an open area whereby seed treatment can be applied to seed passing to the receiving cup 12.

FIG. 3 is a cross-sectional view of the manifold with a means 15 coupling the source of treatment material 22 to the manifold and a means 24 conveying treatment material to said nozzle shield 10 located in at least 1 row crop planter box.

Although this invention has been described with particular reference to a particular environment, various features, construction details and materials, and functional relationships, various changes will be apparent to one skilled in the art and the invention is not to be limited to any particular environment, materials or functional relationships except as set forth in the appended claims.

I claim:

1. A seed treater mounted on an implement having a frame, a seed box mounted on said frame and having at least one opening to the bottom thereof, a seed receiver mounted under and immediately adjacent said opening and in operative relationship thereto, a conduit attached to said seed receiver for receiving seed therefrom and depositing them in the ground and ground support wheels attached to said frame, said seed treater comprising:
a. a source of treatment material attached to said frame,
b. a nozzle shield mounted in said seed box immediately above said opening at a distance therefrom to allow seeds in said seed box to enter said seed receiver, and
c. a means coupling said source of treatment material and said nozzle shield for conveying said treatment material to said nozzle shield.

2. A seed treater as in claim 1 further comprising the steps of:
a. positioning at least one material nozzle shield in said grain box immediately above and in juxtaposition to said seed receiver at such a distance to allow seed in said grain box to enter said seed receiver through said opening, and
b. positioning at least on material nozzle shield in said grain box immediately above and in juxtaposition to said seed receiver using an arm to position said nozzle shield to convey said treatment material to seed vortex as it enters said seed receiver, and
c. mounting a source of treatment material on said frame, and
d. liquid pressure injecting predetermined amounts of said treatment material into said nozzle shield for treating seed.

3. A seed treater mounted on an implement having a frame, a seed box mounted on said frame, a source of treatment material mounted thereon, and coupling means comprising:
a manifold having:
1. an input orifice coupled to said source of treatment material under liquid pressure,
2. output orifices equal in number to said nozzle shields, and
3. means coupling said input orifice with each of said output orifices, and
b. conduits coupling each of said output orifices with a corresponding nozzle shield located within individual seed boxes.
